(19) United States
(12) Patent Application Publication
(10) Pub. No.: US 2005/0239561 A1
(43) Pub. Date: Oct. 27, 2005

(54) INERTIA RING FOR SUPPRESSION OF DRIVESHAFT RADIATED NOISE

(75) Inventors: Takeshi Abe, Garden City, MI (US); Robert Bonhard, Milford, MI (US); Chris Kwasniewicz, Novi, MI (US); Mark Bosca, St Clair Shores, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 10/709,284

(22) Filed: Apr. 27, 2004

(51) Int. Cl. F16C 3/00

(52) U.S. Cl. 464/180

(57) ABSTRACT

An inertia ring is attached to a driveshaft to separate the bending mode and breathing mode of driveshaft vibrations. Separation of the two modes results in the reduction of the overall amplitude of the vibrations and reduces the noise emitted by the driveshaft. The inertia ring may be constructed of either aluminum or steel and is secured to the driveshaft by means of a press fit or by clamping. The inertia ring is fixed at or near a point corresponding to a bending mode antinode adjacent to one end of the driveshaft.

### BACKGROUND OF INVENTION

1. Field of the Invention

The present invention relates to a driveshaft assembly that includes an inertia ring for reducing the noise emitted by the driveshaft due to vibrations in the drivetrain.

2. Background Art

Torque transmitting devices are often used to transfer rotational power from one source to a rotatably driven mechanism. One example of a torque transmitting shaft is a driveshaft used in a powertrain of an automobile. The driveshaft transfers the rotational power from the engine of the automobile to a driven component such as the rear axle. Typically, a vehicle's driveshaft assembly includes a cylindrical shaft having an end fitting secured to each end. One fitting is generally connected to the transmission while the other fitting is connected to the rear axle.

One problem encountered with driveshaft assemblies is that they tend to transmit undesirable noises during operation. All mechanical bodies have resonant frequencies that may cause objectionable noise levels when operated at certain rotational speeds. Resonant frequencies may vary based on factors such as the composition, size and shape of the object. One objective of vehicle design is to reduce the noise caused by the vibration of the driveshaft and provide a quieter ride.

Many different mechanisms have been proposed to dissipate or absorb the vibrations emitted by the automobile's driveshaft during operation. Some of these mechanisms include torsional tuned absorbers, cardboard liners, foam liners, damping sleeves and internally tuned absorbers. Torsional tuned absorbers dissipate energy at a specified frequency by oscillating a mass but are limited to lower frequency applications (e.g. vibrations that are less than 600 Hz). Cardboard liners dissipate energy through frictional losses but are subject to substantial variation in effectiveness due to factors such as fit, humidity at the time of assembly, and whether the liners are plain or corrugated. Foam liners are also of limited use due to variability caused by fit. Damping sleeves function to shift the driveshaft resonance peaks to regions of lower external excitation energy but do not reduce overall noise and vibration. For example, a damping sleeve may be used to shift a drivetrain vibration peak resonance away from a vehicle resonant vibration.

The above prior art noise reduction structures may be assembled into the hollow center of the driveshaft or assembled to the outer surface of the driveshaft. Such noise reduction structures are difficult to install as a retrofit or in a service operation by a mechanic.

### SUMMARY OF INVENTION

These and other problems are addressed by the applicant's invention as summarized below. One proposed solution to these problems is to securely fasten an inertia ring to an antinode nearest the end of the driveshaft for the particular frequency of concern. The inertia ring decouples the bending and breathing modes of the driveshaft preventing the modes from amplifying one another and further increasing vibrations and noise. This invention differs from the prior art designs which are intended to absorb or dissipate the vibrations that are emitted from the driveshaft. Installation of the inertia ring is quick and easy and may be more cost effective and efficient than current designs.

Accordingly, the present invention is directed to applying an inertia ring to the shaft of the driveshaft in order to decouple the bending and breathing modes of the driveshaft thereby reducing the noise emitted due to the vibrations. The breathing mode causes the diameter of the driveshaft to expand and contract. The breathing mode exhibited by the driveshaft can be excited by high frequency gear transmitted gear conjugation error emanating from the transmission or axle gears. Gear conjugation error is an error in force transmission due to angular misalignment of gears as they engage. When the gears do not engage smoothly, vibration may be transmitted to the driveshaft. The bending mode exhibited by the driveshaft is also excited by the same phenomenon.

One aspect of this invention relates to a noise reduction structure comprising an inertia ring that is fixed to a rotating shaft. The rotating shaft has a vibration characteristic that exhibits closely coupled bending modes and breathing modes. The inertia ring, once attached to the rotating shaft, separates the bending and breathing modes exhibited by the rotating shaft and reduces the amplitude of the shaft vibrations. According to one aspect of this invention, the rotating shaft may be a driveshaft. However, the invention is also applicable to other types of shafts.

The inertia ring, constructed of either steel or aluminum, is attached to the driveshaft at an antinode located nearest the end of the shaft. The antinode is the point on the shaft where the vibrations of the shaft tend to have the greatest amplitude. The inertia ring is securely fixed to the driveshaft and does not oscillate or vibrate independently from the driveshaft. Also, the inertia ring is rotationally symmetrical. The weight of the inertia ring can be determined by finite element analysis or from testing.

There are many different methods that may be used to connect the inertia ring to the driveshaft. One such method would be by means of a press fit. The press fit may be achieved by sliding the inertia ring, that has a smaller inner diameter than the outer diameter of the driveshaft, onto the driveshaft. This causes the driveshaft to contract slightly tightly affixing the inertia ring to the driveshaft. The inertia ring may also be fixed by means of a clamp to resolve noise problems as a retrofit for driveshafts of vehicles in the field. Inertia rings that are clamped on the driveshaft are formed in two separate halves that are secured to the driveshaft by means of a fastener.

According to another aspect of the invention, the driveshaft is provided with an inertia ring that is fixed at a specified point on the driveshaft. The inertia ring, if located in the correct location, separates the bending and breathing modes to reduce the amplitude of the resonant frequencies and reduce the noise emitted by the driveshaft.

According to yet another aspect of the invention, a drivetrain is provided for a vehicle having an engine, transmission, differential and driveshaft that is fitted with an inertia ring. The inertia ring has an inner diameter that is fixed at a specified point on the driveshaft. The inertia ring separates the bending and breathing modes at a specified frequency, reducing the amplitude of the resonant frequencies and limiting the amount of noise emitted by the driveshaft.

These and other aspects of the invention will be better understood in view of the attached drawings and the following detailed description of the preferred embodiments.

### BRIEF DESCRIPTION OF DRAWINGS

FIG. 1 shows the engine and driveshafts of a rear wheel drive motor vehicle.

FIG. 2 is a longitudinal section through a first embodiment of the driveshaft with an inertia ring attached.

FIG. 3 shows a section through line 3-3 of FIG. 2 where the inertia ring is installed using a press fit.

FIG. 4 shows an exaggerated section through line 4-4 of FIG. 2 where the inertia ring is installed using a press fit.

FIG. 5 shows a section similar to FIG. 3 but illustrating an inertia ring that is manufactured in two separate halves and installed by clamping the two halves together.

FIGS. 6A-C are drawings demonstrating the resulting bending and breathing modes of a driveshaft without an inertia ring attached.

FIGS. 7A-C are drawings demonstrating the resulting bending and breathing modes of a driveshaft with an inertia ring attached.

FIG. 8 is a graph demonstrating the different sound emitted by the rotation and vibration of a driveshaft at a given frequency comparing a driveshaft without an inertia ring to a driveshaft with an inertia ring of specified weight attached.

### DETAILED DESCRIPTION

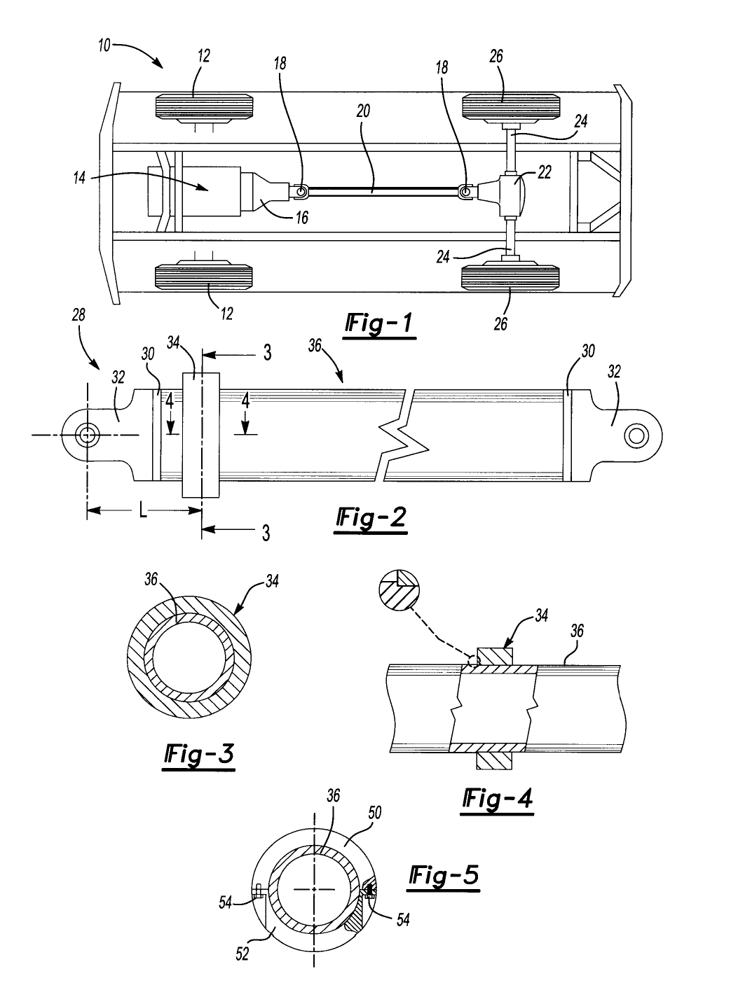

FIG. 1 is a diagram of a rear wheel drive motor vehicle 10 having a pair of front wheels 12 and an engine 14 that is located between the front wheels 12. While the illustrated embodiment is of a rear wheel drive vehicle the invention can also be applied to front wheel drive vehicles and other types of driveshafts. The engine 14 provides power to a longitudinally extending driveshaft 20 through a gear box 16. The gear box 16 is attached to a universal joint 18. The driving torque for the rear wheels 26 is transmitted from the gear box 16 through the longitudinal driveshaft 20. The driveshaft 20 supplies the driving torque to the rear axle differential 22. The rear axle differential 22 provides power to the rear wheels 26 through a pair of rear axle half shafts 24.

FIG. 2 shows a driveshaft assembly 28 with a tube yoke 32 attached to an end fitting 30 that is disposed within each end of the driveshaft 36. The tube yoke 32 is welded to the driveshaft 36. An inertia ring 34 is either press fit or clamped to the driveshaft 36. The inertia ring 34 is placed at a distance L from the end of the driveshaft assembly 28 which corresponds to the location of an antinode that is nearest the end of the driveshaft 36.

FIG. 3 shows a section taken along the line 3-3 of FIG. 2 showing the inertia ring 34 press fit to the driveshaft 36. FIG. 4 shows an exaggerated section along connecting line 4-4 of FIG. 2 that is exaggerated to demonstrate how the inertia ring 34 is press fit onto the driveshaft 36. The diameter of the driveshaft 36 is compressed to a slightly smaller diameter because the inertia ring 34 has an inner diameter that is slightly smaller than the outer diameter of the driveshaft 36.

FIG. 5 shows a section similar to the section taken along the line 3-3 of FIG. 2 through the inertia ring 34 that is clamped onto the driveshaft 36. The clamping arrangement connecting the top half 50 of the inertia ring 34 to the bottom half 52 of the inertia ring 34 may be provided by means of a pair of fasteners 54.

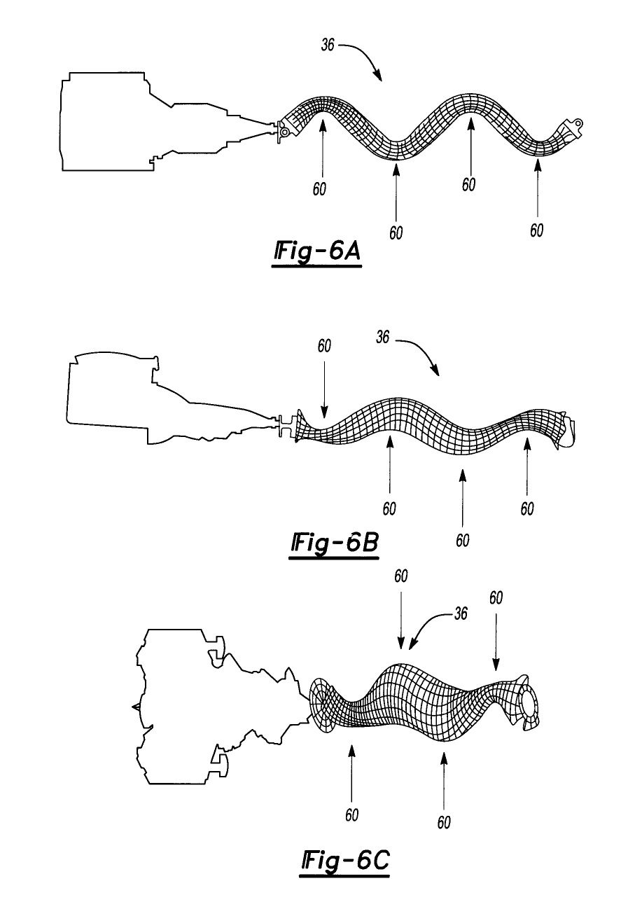

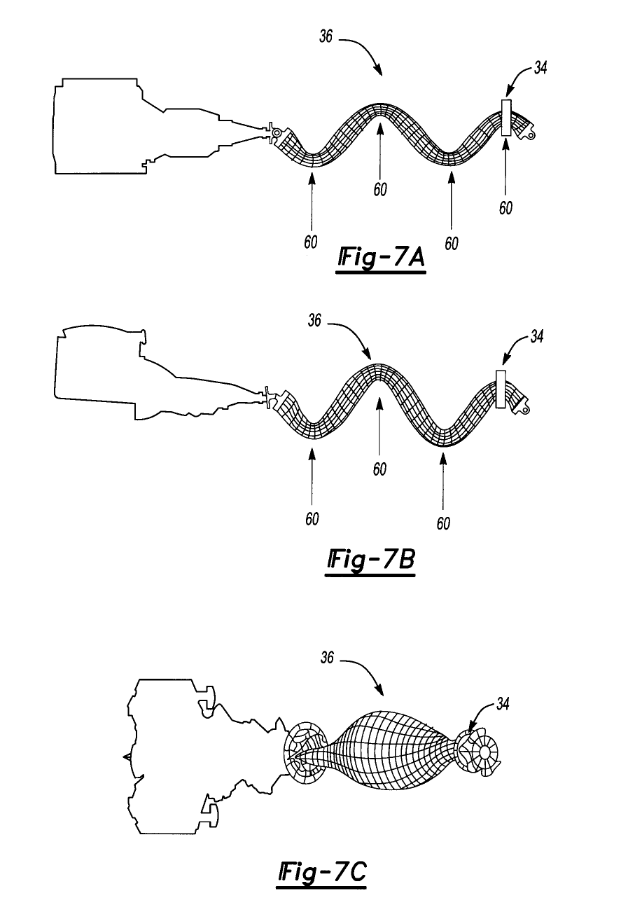

FIGS. 6 and 7 are drawings showing the resulting bending and breathing modes of a driveshaft 36 with different frequencies. FIGS. 6A, 6b and 6C show the resulting modes as the frequency increases without an inertia ring 34 attached. FIGS. 7A, 7b and 7c show the resulting modes as the frequency increases with an inertia ring 34 attached.

FIG. 6A illustrates a driveshaft operating at a frequency that does not create substantial bending and breathing mode resonant vibrations that would indicate a need for an inertia ring. Referring now to FIGS. 6B and 6C, as the frequency increases, the bending and breathing modes increase and are combined along the length of the shaft. This relationship is most apparent in FIG. 6C. A plurality antinodes 60 of the resulting bending mode are clearly visible in FIGS. 6A, 6b and 6C.

FIG. 7A illustrates a driveshaft having an inertia ring operating at a frequency that does not create substantial bending and breathing mode resonant vibrations and when compared to FIG. 6A little change is indicated. FIG. 7b illustrates a driveshaft exhibiting only a bending mode (i.e. oscillations) that is comparable with FIG. 6B and shows a marked reduction of resonant vibrations. FIG. 7C shows a driveshaft primarily exhibiting a breathing mode (i.e. expansion), that is comparable to FIG. 6C and shows a reduction in resonant vibrations. Referring to FIGS. 7B and 7C, bending and breathing modes are decoupled as frequency increases when an inertia ring is attached to a driveshaft encountering problems relating to resonant vibrations.

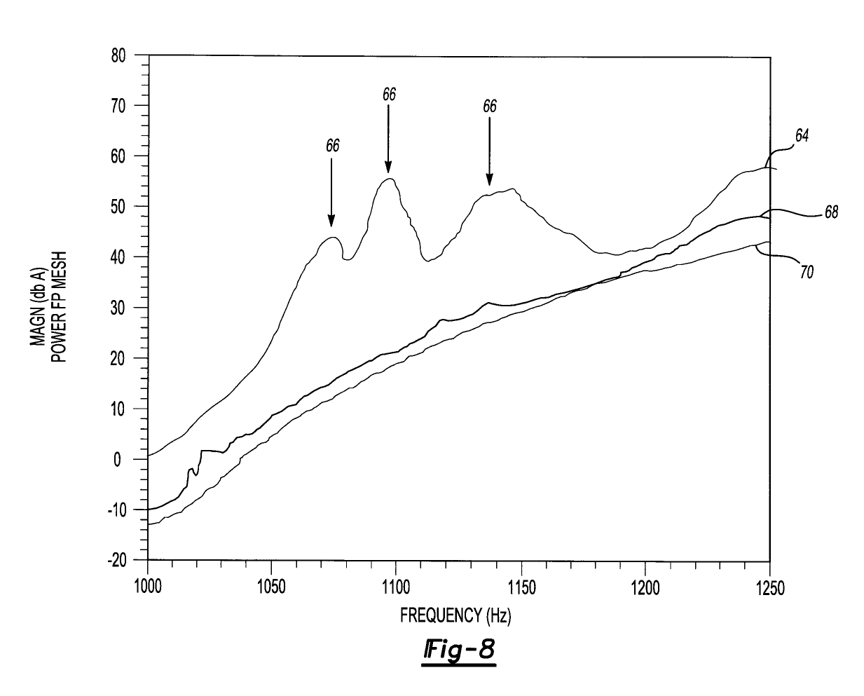

FIG. 8 is a graph comparing the different sound levels created by the rotation and vibration of a sample driveshaft 36 at a given frequency. This graph compares an unmodified response 64 which has no inertia ring 34 to driveshafts 36 with either a 2 pound inertia ring 34 illustrated as response 68 or 9.4 pound inertia ring 34 illustrated as response 70. When either inertia ring 34 is attached there is a substantial reduction in the sound emitted by the driveshaft 36. Both inertia rings 34 create an operating environment where the sound emitted increases gradually as the frequency increases. The use of either inertia ring 34 provides a driveshaft 36 that emits less noise over the majority of the range depicted. In contrast, when there is no inertia ring 34 attached, sound emitted by the driveshaft 36 increases and decreases in an oscillating manner as the frequency increases. As the frequency of the shaft increases there are peaks 66 in the amount of sound emitted. These peaks 66 are most visible in the unmodified response 64 at approximately 1080, 1110 and 1150 Hz.

Weight is an important factor in the design of an automobile. While there is minimal difference in the noise emitted between the 2 pound inertia ring 34 response 68 and 9.4 pound inertia ring 34 response 70, weight reduction design preferences would favor the 2 pound 68 inertia ring 34 for use on a vehicle driveshaft 36.

While the best mode for carrying out the invention has been described in detail, those familiar with the art to which this invention relates will recognize various alternative designs and embodiments for practicing the invention as defined by the following claims.

1. A system comprising an inertial body and a rotating shaft, in combination, the rotating shaft having a vibration characteristic that exhibits a bending mode and exhibits a breathing mode which are closely coupled, the bending mode and breathing mode being decoupled by attaching the inertial body to the rotating shaft proximate a bending vibration antinode to reduce the amplitude of the shaft vibrations.

2. A system according to claim 1, wherein the rotating shaft is a driveshaft.

3. A system according to claim 1, wherein the breathing mode is the expansion and contraction of the shaft excited by high frequency gear transmitted errors from either a transmission or an axle.

4. A system according to claim 1, wherein the bending mode is the oscillation of the shaft caused by the vibrations excited by high frequency gear transmitted errors from either a transmission or an axle.

5. A system according to claim 1, wherein the inertial body is attached to the rotating shaft proximate the bending vibration antinode near the end thereof.

6. A system according to claim 1, wherein the inertial body is fixed to the rotating shaft using a press fit.

7. A system according to claim 1, wherein the inertial body is manufactured in two separate halves and affixed by clamping the two halves to the rotating shaft.

8. A driveshaft for torque transmission purposes especially for use in a drivetrain of a motor vehicle comprising:
a shaft having first and second ends and a central region;
an inertia ring having an inner opening fixed at a specified point on the driveshaft that separates the bending mode created by the vibrations of the driveshaft from the breathing mode created by the vibration of the driveshaft to reduce the amplitude of the resonant frequencies and limit the amount of noise emitted by the driveshaft.

9. A driveshaft according to claim 8, wherein the inertia ring is fixed at a bending antinode nearest one end of the driveshaft.

10. A driveshaft according to claim 8, wherein the outer diameter of the driveshaft is greater than the inner diameter of the inertia ring so that the inertia ring may be press fit in place at a desired location corresponding to an antinode.

11. A driveshaft according to claim 8, wherein the inertia ring is securely fixed to the driveshaft and does not oscillate or vibrate independently from the driveshaft.

12. A driveshaft according to claim 8, wherein the inertia ring is rotationally symmetrical.

13. A driveshaft according to claim 8, wherein the weight of the inertia ring is determined by finite element analysis of the powertrain.

14. A driveshaft according to claim 8, wherein the inertia ring is made of aluminum.

15. A driveshaft according to claim 8, wherein the inertia ring is made of steel.

16. A driveshaft according to claim 8, wherein the weight of the inertia ring is determined by testing.

17. A drivetrain for a vehicle having an engine, transmission, differential and driveshaft connection wherein the driveshaft connection comprises:
a shaft having first and second ends and a central region;
an inertia ring having an inner opening fixed at a specifiedpoint on the driveshaft that separates the bending mode created by the vibrations of the driveshaft from the breathing mode created by the rotation of the driveshaft to reduce the amplitude of the resonant frequencies and limit the amount of noise emitted by the driveshaft.

18. A drivetrain connection according to claim 17, wherein the inertia ring is fixed at an antinode.

19. A drivetrain connection according to claim 17, wherein the diameter of the driveshaft is greater than the inner diameter of the inertia ring so that the inertia ring may be press fit in place at a desired location corresponding to an antinode.

20. A drivetrain connection according to claim 17, wherein the inertia ring is securely fixed to the driveshaft and does not oscillate or vibrate independently from the driveshaft.
